(19) United States
(12) Patent Application Publication
(10) Pub. No.: US 2021/0286306 A1
(43) Pub. Date: Sep. 16, 2021

(54) IMAGE FORMING APPARATUS

(71) Applicant: TOSHIBA TEC KABUSHIKI KAISHA, Tokyo (JP)

(72) Inventor: Shudai HASHIMOTO, Mishima Shizuoka (JP)

(21) Appl. No.: 16/820,617

(22) Filed: Mar. 16, 2020

(51) Int. Cl. G03G 15/00

(52) U.S. Cl. CPC G03G 15/55

(57) ABSTRACT

An image forming apparatus includes an image forming unit, a detector, and a controller. The image forming unit transfers an image from a photoconductor to a transfer body, and then transfers the image to a sheet. The detector detects a positional deviation of a conveying surface of the transfer body from a reference position. The controller executes a correction process including forming a test pattern and a correction control processing including forming the test pattern for the correction pattern based on a detection result from the detector.

### FIELD

Embodiments described herein relate generally to image forming apparatus.

### BACKGROUND

Conventionally, in an image forming apparatus capable of printing a plurality of color toners, a registration correction process is performed in order to prevent the transfer positions of the respective colors from shifting. The correction process is, for example, a process of forming a toner image (test pattern) for alignment on a transfer belt, reading the toner image with a position sensor, and correcting a writing position and a transfer position of an image by using a reading result.

However, the surface of the transfer belt may suffer from fluttering, scratches, and the like. To solve the problem that, when a correction processing is performed in a state where an error due to fluttering or a flaw is included in the correction processing, deviation of the error occurs in the writing position and the transfer position of the corrected image, so that the image quality is deteriorated.

### BRIEF DESCRIPTION OF THE DRAWINGS

FIG. 1 is an external view showing an overall configuration of the image forming apparatus according to the embodiment.

FIG. 2 is a diagram illustrating an internal configuration of the image forming apparatus according to the embodiment.

FIG. 3 is a block diagram illustrating a functional configuration related to the correction process of the image forming apparatus according to the embodiment.

FIG. 4 is an diagram showing the relationship between the output value of the image density sensor and the deviation of the intermediate transfer body according to the embodiment.

FIG. 5 is an diagram showing the configuration of the side portion of the intermediate transfer body according to the embodiment.

FIG. 6 is a diagram showing a variation in the distance between the image density sensor and the belt surface in the one circumference of the intermediate transfer body according to the embodiment.

FIG. 7 is a schematic diagram illustrating a process for detecting a test pattern by the position sensor according to the embodiment.

FIG. 8 is a flowchart illustrating an alignment correction process performed by the image forming apparatus according to the embodiment.

### DETAILED DESCRIPTION

The image forming apparatus of the embodiment includes an image forming portion, a detector, and a controller. The image forming portion transfers the visible image formed on the photosensitive member to the transfer member, and transfers the visible image to the sheet from the transfer member to form a secondary transfer member. The detector detects a deviation from a reference position of the conveying surface of the transfer body. The controller executes a correction process for forming a test pattern on the conveying surface and correcting a positional shift of the visible image formed on the transfer member, and a correction control processing for controlling a position on the conveying surface on which the test pattern is formed in the correction process based on the detection result by the detector.

According to one embodiment, an image forming apparatus including an image forming unit configured to transfer an image from a photoconductor or the like to a transfer body, and then transfer the image from the transfer body to a sheet. A detector is configured to detect a positional deviation of a conveying surface of the transfer body from a reference position. A controller is configured to execute a correction processing including forming a test pattern on the conveying surface of the transfer body, and execute a correction control processing including forming the test pattern for the correction processing based on a detection result from the detector.

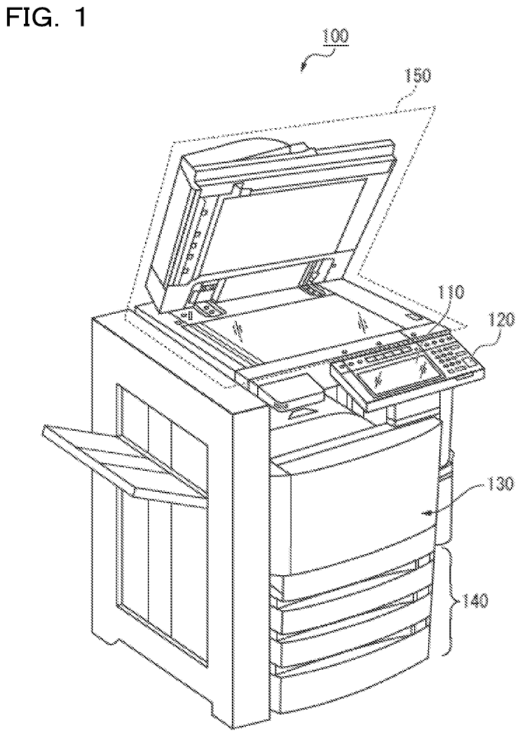

FIG. 1 is an external view showing an overall configuration example of the image forming apparatus 100 according to the embodiment. The image forming apparatus 100 is, for example, a multi-function peripheral. The image forming apparatus 100 includes a display 110, a control panel 120, a printer 130, a sheet storage 140, and an image reading unit 150.

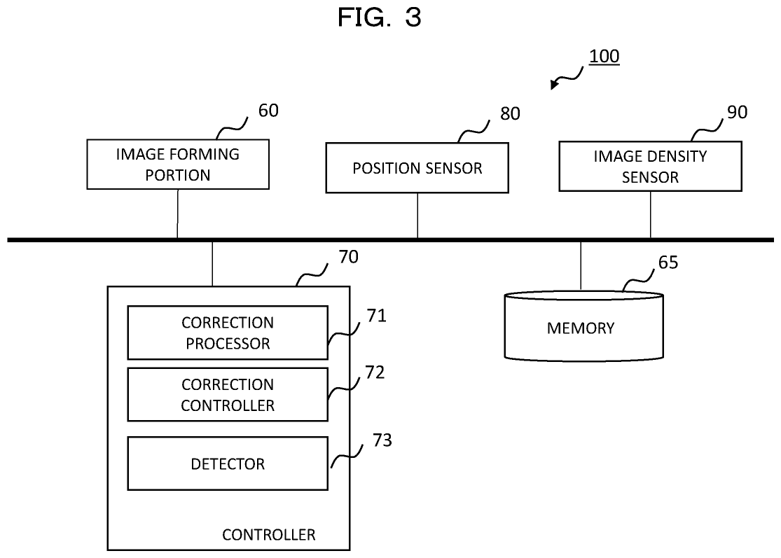

The display 110 is a liquid crystal display provided with a touch panel. The display 110 displays various kinds of information. Further, the display 110 receives an operation from a user. The display 110 displays various operation screens, image states, operating conditions of each function, and the like in accordance with a display control signal output from a controller 70 (see FIG. 3).

The control panel 120 is provided with various operation keys such as a numeric keypad and a start key. The control panel 120 receives various input operations from the user. Also, the control panel 120 outputs an operation signal corresponding to various input operations accepted from the user to the controller.

The printer 130 performs a series of printing operations by using various kinds of information output from the display 110, the control panel 120, the image reading unit 150, and the like. A series of printing operations includes an operation of inputting image information, an operation of forming an image, an operation of transferring a formed image to a sheet, an operation of conveying a sheet, and the like.

The sheet storage 140 includes a plurality of sheet cassettes. Each sheet cassette contains a sheet or sheets.

The image reading unit 150 includes an automatic document feeding apparatus and a scanner apparatus. The automatic document feeder sends a document placed on a document tray to the scanner apparatus. The scanner apparatus optically scans a document on an original glass platen, and forms a reflected light from a document on a light receiving surface of a CCD (Charge Coupled Device) sensor. Thus, the scanner apparatus reads the original image on the original glass platen. The image reading unit 150 generates image information (image data) using the reading result read by the scanner apparatus.

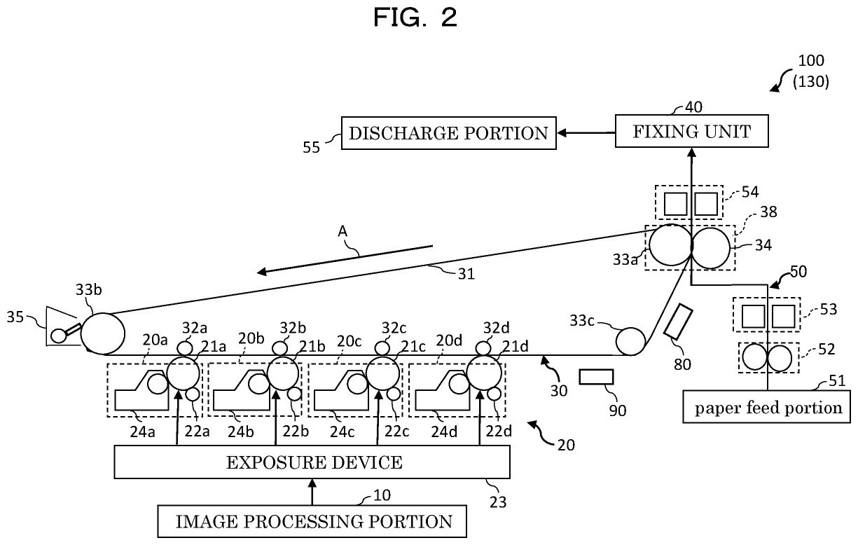

FIG. 2 is a diagram illustrating an internal configuration of the image forming apparatus 100. As shown in FIG. 2, image forming apparatus 100 (printer 130) comprises four image forming units 20a to 20d in parallel. Image forming apparatus 100 is a so-called four-tandem image forming apparatus. The image forming apparatus 100 includes an image processing portion 10, an image forming unit 20 (20a to 20d), an intermediate transfer unit 30, a fixing unit 40, a sheet conveying unit 50, a position sensor 80, and an image density sensor 90.

The image processing portion 10 inputs image information. The image information to be inputted is image information generated by the image reading unit 150 or image information transmitted from another apparatus. The image processing portion 10 performs digital image processing for processing the input image information according to the initial setting or the setting of the user. For example, digital image processing includes correction of gray scale based on tone correction data. In addition to gradation correction, digital image processing includes processing such as color correction, shading correction, and the like, and processing such as compression, for image data.

Next, the image forming unit 20 (the image forming units 20a to 20d) will be described. The image forming unit 20 includes an image forming unit 20a corresponding to Y (yellow), an image forming unit 20b corresponding to M (magenta), an image forming unit 20c corresponding to C (cyan), and an image forming unit 20d corresponding to K (black). Each image forming unit 20a to 20d includes a photoconductor drum 21a to 21d, a charger 22a to 22d, an exposure device 23, a developing device 24a to 24d, a drum cleaner (not shown), and the like. In the following description, a description will be given of a case where a to d is omitted.

The photoconductor drum 21 is an organic photoconductor (OPC) in which an undercoat layer, a charge generation layer, and a charge transport layer are sequentially laminated on the peripheral surface of a conductive cylinder made of aluminum, for example. The photoconductor drum 21 has a photoconductive property.

The charging device 22 generates corona discharge. The charging device 22 uniformly charges the surface of the photoconductor drum 21.

The exposure device 23 is a semiconductor laser. The exposure device 23 irradiates the photoconductor drum 21 with laser light corresponding to the image of each color component. When the laser beam is irradiated by the exposure device 23, the potential of the region irradiated with the laser beam is changed in the region of the surface of the photoconductor drum 21. By this potential change (potential difference), electrostatic latent images are formed on the surfaces of photoconductor drum 21.

The developing device 24 accommodates the developer. The developing device 24 attaches toner of each color component to the surface of the photoconductor drum 21. As a result, a toner image is formed on the photoconductor drum 21. That is, the electrostatic latent image formed on the surface of the photoconductor drum 21 is visualized.

Here, the developer will be described. A two-component developer is used as the developer. The two-component developer comprises a non-magnetic toner and a carrier. For the carrier, for example, iron powder having a particle diameter of 10 μm or polymer ferrite particles may be used. The carrier is mixed with the toner in the developing device 24 to be triboelectrically charged to give a charge (for example, a negative charge) to the toner. Also, the carrier conveys the toner to the electrostatic latent image portion by magnetic force. However, the developer is not limited to a two-component developer, and a one-component developer without using a carrier may also be used.

A drum cleaner, not separately depicted, comprises a cleaning blade that contacts the surface of the photoconductor drum 21. The cleaning blade removes residual toner from the surfaces of photoconductor drum 21 after the primary transfer process. The removed residual toner is collected in a receiving portion of the drum cleaner.

Next, the intermediate transfer unit 30 will be described. The intermediate transfer unit 30 includes an intermediate transfer body 31, a primary transfer roller 32 (primary transfer rollers 32a to 32d), a plurality of support rollers 33 (support rollers 33a to 33c), a secondary transfer roller 34, and a belt cleaner 35.

The intermediate transfer body 31 is an endless belt (a loop). The intermediate transfer body 31 is electrically conductive and elastic.

The support rollers 33a to 33c support the intermediate transfer body 31 in such a manner that tension is applied to the intermediate transfer body 31. As a result, the intermediate transfer body 31 is formed in a loop shape. Among the support rollers 33a-33c, one of the rollers (for example, the support roller 33c) is a drive roller. The rollers other than the drive roller are driven rollers. When the drive roller is driven to rotate, the intermediate transfer body 31 runs at a predetermined speed in the direction A.

Here, the direction in which the intermediate transfer body 31 moves can be defined in the upstream direction and in the downstream direction. Specifically, the direction in which the intermediate transfer body 31 moves can be defined by setting the image forming unit 20a to the most upstream side and the belt cleaner 35 to the most downstream side.

The primary transfer roller 32 is disposed opposite to the photoconductor drum 21 via the intermediate transfer body 31. Specifically, the primary transfer roller 32 is arranged such that pressure is applied to the photoconductor drum 21 with the intermediate transfer body 31 interposed therebetween. Thus, a primary transfer portion for nipping the intermediate transfer body 31 is formed between the primary transfer roller 32 and the photoconductor drum 21.

When the intermediate transfer body 31 passes through the primary transfer portion, a toner image formed on the photoconductor drum 21 is transferred onto the intermediate transfer body 31. When the intermediate transfer body 31 passes through the primary transfer portion, a primary transfer bias is applied to the primary transfer roller 32. Specifically, a charge having an opposite polarity (positive polarity) to the toner is applied to the primary transfer roller 32. As a result, the toner image formed on the photoconductor drum 21 is electrostatically transferred to the intermediate transfer body 31.

The secondary transfer roller 34 is disposed opposite to the support roller 33a via the intermediate transfer body 31. Specifically, the secondary transfer roller 34 is arranged so that pressure is applied to the support roller 33a with the intermediate transfer body 31 interposed therebetween.

Thus, the secondary transfer roller 34 and the support roller 33a form the secondary transfer portion 38 for nipping the intermediate transfer body 31 and the sheet.

When the sheet passes through the secondary transfer portion 38, the toner image on the intermediate transfer body 31 is transferred onto the sheet. When the sheet passes through the secondary transfer portion 38, a secondary transfer bias is applied to the support roller 33a. Specifically, a charge having the same polarity (negative polarity) as that of the toner is applied to the support roller 33a.

As a result, the toner image on the intermediate transfer body 31 is electrostatically transferred to the sheet. The secondary transfer roller 34 and the support roller 33a are configured to be moved apart from each other. Thus, if the sheet becomes jammed in the secondary transfer portion 38, the user can remove the sheet.

The belt cleaner 35 includes a cleaning blade that contacts a surface of the intermediate transfer body 31. The cleaning blade removes residual toner remaining on the surface of the intermediate transfer body 31 after the secondary transfer. The residual toner thus removed is collected in a storage portion of the belt cleaner 35.

The fixing unit 40 is a device that heats and presses the sheet onto which the toner image has been transferred. As a result, the fixing unit 40 fixes the toner image on the sheet. It is also possible to apply a method of fixing the toner image to a sheet by heating the toner image using a film-like heating member (thin film heater) within the fixing unit 40.

Next, a description will be given of the sheet conveying unit 50. The sheet conveying unit 50 includes a paper feed portion 51, a alignment portion 52, a first guide portion 53, a second guide portion 54, and a paper discharge portion 55.

The paper feed portion 51 conveys the sheets from the sheet storage 140 to the alignment portion 52. The alignment portion 52 stops the sheet that has been conveyed from the paper feed portion 51, and then sends the sheet to the secondary transfer portion 38 at a predetermined timing. The predetermined timing is the appropriate feed timing for which the toner image formed on the intermediate transfer body 31 can be secondarily transferred to the sheet by the secondary transfer process.

The first guide portion 53 regulates the conveyance direction of the sheet sent out from the alignment portion 52. The first guide portion 53 sends the sheet at the appropriate timing in the conveyance direction towards the secondary transfer portion 38.

The secondary transfer portion 38 transfers the toner image to the sheet after the sheet conveyance timing has been regulated by the first guide portion 53. The secondary transfer portion 38 then sends the sheet after the toner image has been transferred thereto on to the fixing unit 40.

The secondary guide portion 54 regulates the conveyance of the sheet sent out from the secondary transfer portion 38. The fixing unit 40 then heats and presses the sheet after the sent has passed the second guide unit 54, and then feeds the sheet after fixing to the paper discharge portion 55. The paper discharge portion 55 then feeds the sheet (the now-printed sheet) to the discharge tray.

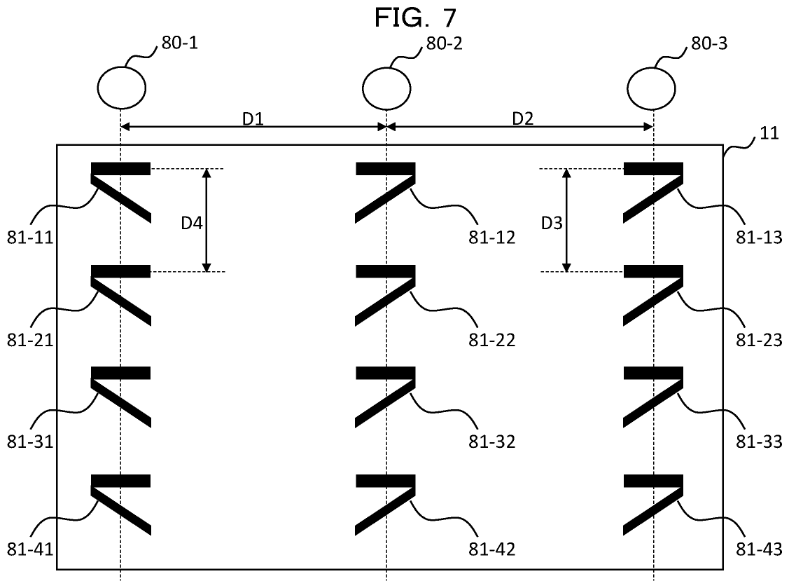

The position sensor 80 is fixed to the upstream side of the secondary transfer position, and detects a correction pattern formed on the intermediate transfer body 31. In the following description, the correction pattern may be referred to as a “test pattern”. In general, the correction pattern is used to adjust alignment/positions/timings used in the image forming processes. The position sensor 80 (see also FIG. 7), includes a rear position sensor 80-1, a center position sensor 80-2, and a front side position sensor 80-3. The position sensor 80 can be an optical sensor. In this context, “front” and “rear” sides are referenced to the main body of the image forming apparatus 100, the “front side” being that side generally facing towards an apparatus user or the like.

The image density sensor 90 is an optical sensor which is fixed to the upstream side of the secondary transfer position and which detects the density of the toner image before the secondary transfer (hereinafter referred to as “image density”) occurs. Specifically, the image density sensor 90 detects the image density based on the intensity of the reflected light (e.g., specular reflection light or diffuse reflection light) from light irradiated toward the toner image. The image density sensor 90 outputs an output value corresponding to the amount of the reflected light. This output value is a low value when the image density is high (dark), and is high when the image density is low (thin). The image density sensor 90 can include a rear side image density sensor, a central image density sensor, and a front side image density sensor. In this context, “front” and “rear” sides are referenced to the main body of the image forming apparatus 100, the “front side” being that side generally facing towards an apparatus user or the like.

FIG. 3 is a block diagram illustrating a functional configuration associated with the correction process of the image forming apparatus 100 of the embodiment. The correction process is a process for correcting the positional deviation of the visible image formed on the image bearing member (that is, the intermediate transfer body 31) of the image forming portion 60. The correction processing is performed by forming a predetermined shape (hereinafter referred to as “test pattern”) on the intermediate transfer body 31, and detecting the magnitude and direction of the positional deviation based on information such as the distance between the formed test patterns. The image forming apparatus 100 includes an image forming portion 60, a memory 65, a controller 70, the position sensor 80, and the image density sensor 90.

The controller 70 includes a correction processor 71, a correction controller 72, and a detector 73. The correction processor 71 performs alignment control based on the detection result of the position sensor 80. The alignment control is or can include a skew correction processing, a sub-scanning position correction processing, a main scanning magnification correction processing, a main scanning position correction processing, a main scanning partial magnification correction processing, and the like. The controller 70 is implemented by a processor such as a CPU. The controller 70 functions as a correction processor 71, a correction controller 72, and a detector 73 when the program is executed by the processor.

The memory 65 stores various programs to be executed by the correction processor 71, the correction controller 72, and the detector 73. Moreover, the memory 65 stores a determination value when an abnormality in the intermediate transfer body 31 is detected by the detector 73, an output value of the image density sensor 90, and information indicating a timing at which the abnormality of the intermediate transfer body 31 is detected, which is specified by the correction controller 72. The memory 65 includes a storage device such as a magnetic hard disk device or a semiconductor storage device.

The image density sensor 90 includes a light emitting element and a light receiving element. The image density sensor 90 is used for maintaining the image quality. When the light source control voltage corresponding to the light quantity specified by the controller 70 is output from a D/A converter, the light emitting element emits light corresponding to the light quantity control voltage towards the transfer belt (intermediate transfer body 31). The light receiving element receives the light reflected by the toner image formed on the intermediate transfer body 31 and the intermediate transfer body 31. The image density sensor 90 converts a voltage corresponding to the amount of reflected light into a digital value by the A/D converter, and transmits this digital value to the controller 70 (more specifically detector 73 in this example).

The detector 73 detects a deviation from the reference position of the conveying surface of the intermediate transfer body 31. The reference position matches the position when there is no fluttering or other positional deviation of the conveying surface. The deviation detected by the detector is a deviation in the direction orthogonal to the conveying surface of the intermediate transfer body 31. The direction orthogonal to the conveying surface is orthogonal to the main scanning direction and the sub-scanning direction. In the present embodiment, the detector 73 can detect the deviation of the intermediate transfer body 31 by using the output result of the image density sensor 90.

The correction controller 72 controls the position on the conveying surface for forming the test pattern in the correction process based on the detection result by the detector 73. In the following description, the conveying surface of the intermediate transfer body 31 may be referred to as a surface of the intermediate transfer body 31 or a belt surface of the intermediate transfer body 31.

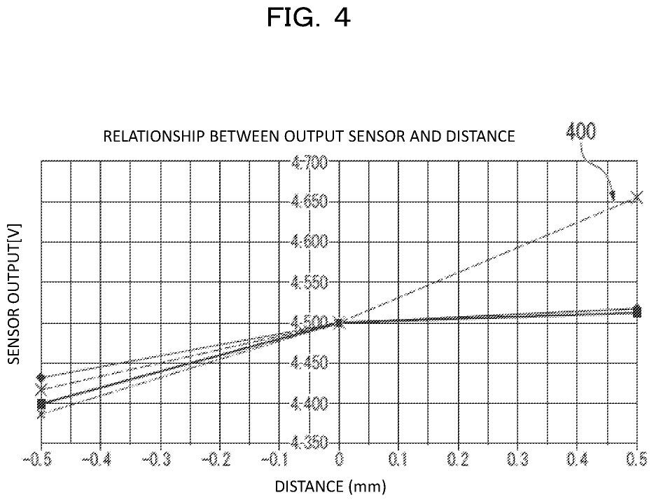

Next, with reference to FIG. 4, the relationship between the output result of the image density sensor 90 and the distance from the image density sensor 90 to the surface(s) of intermediate transfer body 31 will be described.

FIG. 4 is a diagram showing the relationship between the output value of the image density sensor 90 and the deviation of the intermediate transfer body 31. In FIG. 4, the vertical axis indicates the output voltage (V) of the image density sensor 90 in a state in which no image is formed. The horizontal axis indicates a deviation (deflection=fluttering) in a direction orthogonal to the surface of the intermediate transfer body 31. The positive direction on the horizontal axis indicates the direction away from the image density sensor 90. In addition, the negative direction in the horizontal axis indicates the direction approaching the image density sensor 90. Here, if the deviation of the intermediate transfer body 31 is within approximately 0.15 mm (150 μm), it is possible to perform the alignment correction process without causing deterioration in image quality.

In FIG. 4, four different plots are shown overlaid for convenience of description, but a similar tendency is obtained when more that four different plots are plotted together. In FIG. 4, the four types of plots show the measurement results from four image density sensors 90. As shown in FIG. 4, there is a correlation between the output value of the image density sensor 90 and the distance to the surface of the intermediate transfer body 31. The straight line 400 in FIG. 4 shows the correlation when the most significant variation appears.

As shown in FIG. 4, when the output value of the image density sensor 90 is equal to or less than 4.540V, the deviation in the intermediate transfer body 31 is approximately 0.15 mm or less. Further, when the output value of the image density sensor 90 is 4.470V or more, the deviation of the intermediate transfer body 31 is approximately −0.15 mm or more. Therefore, the detector 73 can detect the deviation of the intermediate transfer body 31 based on the output result of the image density sensor 90.

If the output value of the image density sensor 90 is within the range of the judgment value (4.470V to 4.540V), it can be estimated that the fluttering on the surface of the intermediate transfer body 31 is within an allowable range (this condition may be referred to as a normal state or allowable state). Therefore, when the output value of the image density sensor 90 is within the range of 4.470V to 4.540V, the detector 73 does not detect an abnormality.

On the other hand, if the output value of the image density sensor 90 is not within the range of 4.470V to 4.540V, it can be estimated there is a fluttering of the surface of the intermediate transfer body 31 (that is, the state is abnormal or there is an abnormality in condition). Therefore, when the output value of the image density sensor 90 is less than 4.470V or exceeds 4.540V, the detector 73 detects an abnormality.

A sensor to be used for detecting a positional deviation of the surface of the intermediate transfer body 31 is not limited to an image density sensor 90. For example, in some examples, a dedicated sensor for detecting a deviation on the surface of the intermediate transfer body 31 may be provided.

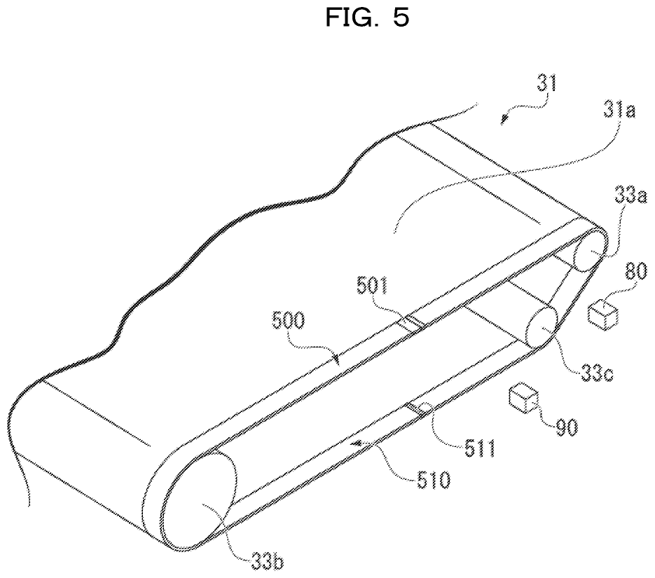

Here, an example of the cause of a fluttering of the intermediate transfer body 31 will be described with reference to FIG. 5. FIG. 5 is an explanatory diagram showing an example of the configuration of the side portion of the intermediate transfer body 31. The intermediate transfer body 31 has a transfer belt 31a. The transfer belt 31a is stretched around the plurality of support rollers 33a to 33c, and is conveyed as an endless belt or loop shape. A reinforced member 500 is provided on the outer periphery of the side (edge) portion of the intermediate transfer body 31. The reinforced member 500 is, for example, a reinforcing tape/film for preventing the transfer belt 31a from being damaged. The reinforced member 500 is in this instance formed with a seam line 501. The seam line 501 corresponds to where the reinforced member 500 overlapped and sewn to the transfer belt 31a, as shown in the figure.

Ribs 510 are provided on the inner periphery of the side portion of the intermediate transfer body 31 so as to prevent the transfer belt from being shifted during conveyance. A joint 511 is formed in the depicted rib 510. Joint 511, as shown in FIG. 5, corresponds to a gap portion in which rib 510 is not disposed. That is, in this instance, the ribs 510 are not completely continuous along the entire length of transfer belt 31a.

Here, when the intermediate transfer body 31 is driven and the seam line 501 passes through the support rollers 33a to 33c, the seam line (sewn portion) 501 may ride up on the support rollers 33a to 33c due to the increased thickness of the seam line 501. As a result, the intermediate transfer body 31 may have an abnormality (e.g., fluttering).

Further, when the intermediate transfer body 31 travels and the joint 511 of the rib 510 passes over the support roller 33a to 33c, a step change in position may be generated due to a relative depression in height caused by the presence of the joint 511 (gap portion). As a result, the intermediate transfer body 31 may have an abnormality (e.g., fluttering).

Here, a description will be given of the occurrence of an abnormality (e.g., fluttering or the like) when passing over the support rollers 33a to 33c. First, the support roller 33a will be described. A secondary transfer roller 34 is disposed opposite to the support roller 33a, and a nip area is formed by the secondary transfer portion 38. Therefore, when the seam line 501 and the joint 511 pass over the support roller 33a, an abnormality (fluttering) occurring on the surface of the intermediate transfer body 31 is unlikely to occur. The support roller 33a is an example of a first roller.

On the other hand, since the nip area is not formed in the support rollers 33b and 33c, a fluttering is likely to occur on the surfaces of the intermediate transfer body 31 as compared to the case where the seam line 501 and the joint 511 pass over the support roller 33a.

Here, between the support roller 33b and the support roller 33c, four image forming units 20a to 20d are disposed, and a nip area is formed by the primary transfer portion. Therefore, the fluttering of the surfaces of the intermediate transfer body 31 generated when the seam line 501 and the joint 511 pass over the support roller 33b is easily absorbed in the nip area of the primary transfer portion, and hardly affects the output value of the image density sensor 90.

On the other hand, since the nip area is not formed in the support roller 33c, when the seam line 501 and the joint 511 pass over the support roller 33c, fluttering is likely to occur on the surface of the intermediate transfer body 31. Also, since the image density sensor 90 is close to the support roller 33c, an output value indicating an abnormality is easy to be detected.

As described above, when the seam line 501 and the joint 511 pass over the support roller 33c, fluttering is likely to occur on the surfaces of the intermediate transfer body 31. The support roller 33c is an example of a second roller. The abnormality on the surfaces of the intermediate transfer body 31 is not limited to such a case, but may also include scratches generated on the intermediate transfer body 31.

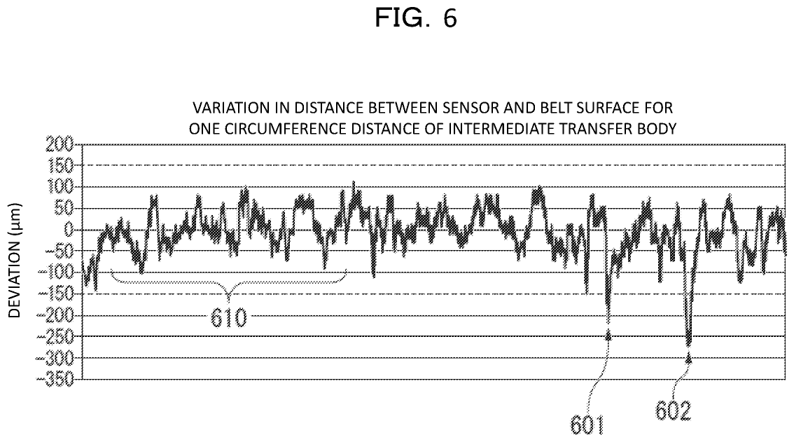

Here, an example of a specific value of the output value of the image density sensor 90 in a state where no image is formed will be described with reference to FIG. 6. FIG. 6 is a diagram showing a variation in the distance between the image density sensor 90 and the surface of the transfer belt 31a in the one circumference of the intermediate transfer body 31. In FIG. 6, the vertical axis indicates the deviation obtained from the output value of the image density sensor 90. The vertical axis “0” corresponds to the reference position. The horizontal axis indicates a movement distance from the reference position. Each position along the horizontal axis can be considered to be a distance from an arbitrary reference point along the rotational circumference of the intermediate transfer body 31 calculated according to the number of revolutions of a driving motor used for rotating the intermediate transfer body 31.

The abnormal positions 601 and 602 shown in FIG. 6 indicate positions where deviation is lower than −150 μm, and there is a fluttering (abnormality) of the intermediate transfer body 31. The abnormal position 601 indicates a fluttering occurring when the seam line 501 of the reinforced member 500 passes over the support roller 33c. The abnormal position 602 indicates a fluttering occurring when the joint 511 of the rib 510 passes over the support roller 33c.

The abnormality shown at the abnormal position 601 and the abnormal position 602 will be generated in a periodic manner corresponding to the travel speed of the intermediate transfer body 31. If the alignment is not corrected at the timing (“abnormal timing”) at which an abnormality occurs at the abnormal position 601 and the abnormal position 602, the image quality may deteriorate.

In this example embodiment, when the seam line 501 and the joint 511 pass over the support roller 33c, the detector 73 detects an abnormality (fluttering) of the surfaces of the intermediate transfer body 31. Furthermore, the correction controller 72 detects a timing of fixed periodic type abnormality that occur repeatedly as the detector 73 detects abnormalities as intermediate transfer body 31 rotates at a fixed or known speed. Specifically, the correction controller 72 causes the intermediate transfer body 31 to rotate at least once (one full rotation travel distance) before the correction processing by the correction processor 71, and thus the correction controller 72 can identify the periodic timing (abnormality timing) at which an abnormality is detected by the detector 73 as the intermediate transfer body 31 rotates.

The abnormal timing may be specified based on the position at which the abnormality is detected, or may be specified based on a time measurement. When the abnormal timing is specified based on the position where the abnormality is detected, the correction controller 72 may specify the rotation speed (position) of the drive motor when an abnormality is detected from a reference point. Further, the correction controller 72 can identify the abnormal timing by using the specified rotation speed of the drive motor, the cycle of the intermediate transfer body 31, the number of motor revolutions required for one round trip of the intermediate transfer body 31, or the like. In addition, when specifying the abnormal timing based on the time, the correction controller 72 may specify the time at which the abnormality has been detected by using a timer, counter, clock, or the like, started/initialized based on the time at which rotation of the intermediate transfer body 31 is started as a reference point.

Further, the correction controller 72 inhibits at least a part of the processing (for example, the reading processing of the test pattern) from among the correction processing at the abnormality time(s), and controls the position at which the test pattern in the correction processing is to be formed. The correction controller 72 may allow the intermediate transfer body 31 to run at least once before the correction controller 72 performs the correction process, and specify a period during which no abnormality is detected by the detector 73 during the travel (“normal time”). In this case, the correction controller 72 may allow the correction processing to be executed at the specified normal time(s).

Further, the correction controller 72 causes the correction processor 71 to form a correction pattern at a position where the deviation detected by the detector 73 is relatively small. In FIG. 6, the interval 610 is a position where the deviation is relatively small because the deviation of the intermediate transfer body 31 is within the range of ±0.10 mm (100 μm). For this reason, the correction controller 72 forms a correction pattern at the section 610.

In addition, in the present embodiment, when a test pattern is read by the position sensor 80 at the abnormality times, an error occurs in the reading operation. Specifically, when the test pattern is read by the position sensor 80 at the abnormal times, an error due to fluttering will be included in the read result, so that an appropriate correction process cannot be performed. Therefore, the correction controller 72 inhibits at least the reading process of the test pattern at the abnormal times that have been indicated/identified as the abnormal position 601 and the abnormal position 602.

Even when the test pattern is transferred to the intermediate transfer body 31 at the abnormal times corresponding to the abnormal position 601 and the abnormal position 602, the intermediate transfer body 31 is being nipped at the primary transfer portion, so that a large positional deviation is unlikely to occur. Specifically, even when the transfer processing is performed at the abnormal times, the error due to the fluttering tends to be smaller than that in the reading processing. For this reason, the correction controller 72 may execute the transfer process of the test pattern even at the abnormal times corresponding to in the abnormal position 601 and the abnormal position 602 without too much concern. However, in order to more accurately perform correction processing, the correction controller 72 may also prohibit the transfer process of the test pattern to the intermediate transfer body 31 at the abnormal times corresponding to the abnormal position 601 and the abnormal position 602.

As described above, the positional deviation in the surfaces of the intermediate transfer body 31 may be caused by the presence of scratches on the surfaces of the intermediate transfer body 31 in addition to the looseness due to the seam line 501 and the joint 511 passing over the support roller 33c. In this case, the correction controller may inhibit the formation (for example, transfer processing) of the test pattern in the portion(s) where such surface defects exists (such surface defects will also generally appear with a fixed periodicity when the intermediate transfer body 31 is rotated at a fixed speed), thereby permitting the correction process to be performed to more accurately.

In addition, in the present embodiment, it is assumed that the abnormal time(s) is identify immediately before a correction processing by the correction processor 71 is performed so the detecting of the abnormalities can be the most up to date possible with respect to correction processing time. However, in many circumstances, the abnormal time(s) associated with the intermediate transfer body 31 rotation is not likely to vary very often or from one time to the next. For this reason, the identification process for abnormalities is not limited to being performed immediately before the correction processing (by the correction processor 71) is performed. For example, the identification of the abnormal time(s) may be performed during a print job, after a predetermined number of print jobs have been completed, after a fixed number of sheets have been printed, at apparatus startup time, after the elapse of a predetermined time period, at a specific time of day, or the like.

Next, the outline of the process for detecting the test pattern by the position sensor 80 will be briefly described. FIG. 7 is a schematic diagram showing a process for detecting a test pattern by the position sensor 80. As shown in FIG. 7, a plurality of (for example, three) position sensors 80 (80-1, 80-2, 80-3) are arranged side by side in the main scanning direction. For convenience of description, the position sensor 80-1 will be referred to as a “rear position sensor 80-1”, the position sensor 80-2 will be referred to as a “center position sensor 80-2”, and the position sensor 80-3 will be referred to as a “front position sensor 80-3”. Note that the in this context “front” and “rear” are references to the front and rear of the image forming apparatus 100 itself. For example, in this context, the front side of the image forming apparatus 100 is the side on which the control panel 120 is installed. The rear side of the image forming apparatus 100 is a side opposite to the front side (generally, a side facing a wall surface or the like). A center position sensor 80-2 is installed at a position between the rear position sensor 80-1 and the front position sensor 80-3.

The rear position sensor 80-1 detects a test pattern formed on the rear side portion of the intermediate transfer body 31 along the main scanning direction. The center position sensor 80-2 detects a test pattern formed in the center portion of the intermediate transfer body 31 along the main scanning direction. The front position sensor 80-3 detects a test pattern formed on the front side portion of the intermediate transfer body 31 along the main scanning direction.

In FIG. 7, D1 represents the distance in the main scanning direction between the center point of the detection region of the rear position sensor 80-1 and the center point of the detection region of the center position sensor 80-2. In FIG. 7, D2 represents the distance in the main scanning direction between the center point of the detection region of the center position sensor 80-2 and the center point of the detection region of the front position sensor 80-3. In general, distances D1 and D2 may be the same distance or different from each other.

The test pattern is formed for each of yellow (Y), magenta (M), cyan (C), and black (K). The test pattern is a pattern in which a plurality of wedge-shaped patterns are arranged in the sub-scanning direction. The wedge-shaped pattern includes a line segment extending in the main scanning direction and a line segment extending at an oblique direction with respect to the scanning direction.

Specifically, the test pattern is formed corresponding to the detection region of each position sensor 80. On the same main scanning line, a pattern 81-11, a pattern 81-12 and a pattern 81-13 are formed side by side. The pattern 81-11 is formed so that a substantially central portion thereof is positioned in the center of the detection region of the rear position sensor 80-1. The pattern 81-12 is formed such that a substantially central portion thereof is positioned in the center of the detection region of the center position sensor 80-2. The pattern 81-13 is formed such that a substantially central portion thereof is positioned in the center of the detection region of the front position sensor 80-3.

A plurality of patterns are formed in the sub-scanning direction as one set. A pattern using different types of developers may be formed in the sub-scanning direction. Patterns 81-11, 81-12 and 81-13 may be formed by cyan, patterns 81-21, 81-22 and 81-23 may be formed by magenta, patterns 81-31, 81-32 and 81-33 may be formed by yellow, and patterns 81-41, 81-42 and 81-43 may be formed by black toner. A plurality of these patterns are formed as one set of patterns. The correction processing is performed on the basis of the width and the distance of each pattern included in the one set.

Here, the length in the sub-scanning direction necessary for forming the plurality of patterns (test patterns) is about ¼ of the total length of the intermediate transfer body 31 (entire transfer belt 31a). In general use, it is possible for the intermediate transfer body 31 to suffer from fluttering (abnormality) or scratching at so many places that a test pattern cannot be formed. Therefore, it can be difficult for the intermediate transfer body 31 to perform the correction process.

However, as shown in FIG. 6, abnormalities may be detected at a plurality of places, such as the abnormality at the abnormal position 601 and the abnormal position 602. In particular, it is assumed that a plurality of flaws can be on the surfaces of the transfer belt 31a. There can be cases where the spacing interval between the flaws is narrow, and thus the length along the sub scanning direction necessary for forming the test pattern cannot be secured. In such a case, the test pattern may not be formed for correction processing in the narrow interval available.

Processing for skew correction, position correction in the sub-scanning direction, and position correction in the main scanning direction will be briefly described.

First, skew correction will be described. Based on the values of D3 and D4 shown in FIG. 7, the skew between the formation of the visible image of the type of toner used in the patterns 81-11, 81-12, 81-13 and the formation of the visible image of the toner of the type used in the patterns 81-21, 81-22, 81-23 can be calculated. Based on the calculated values, a parameter for correcting the inclination can be calculated. Specifically, the inclination of the image used for forming, for example, a visible image is corrected so that the difference between D3 and D4 becomes 0. In this manner, skew correction is performed.

Next, the position correction in the sub-scanning direction will be described. When the magenta patterns 81-21, 81-22, 81-23 are defined as the reference patterns, a reference value D3′ (=D4′) is defined in advance as a distance in the sub-scanning direction between each pattern of cyan and each pattern of magenta. In the sub-scanning position correction processing, the distance D3 (=D4) in the sub-scanning direction is corrected so as to coincide with the reference value D3′. By such correction processing, the distance between the position of the cyan visible image and the position of the magenta visible image are corrected so that the distance in the sub-scanning direction coincides with the reference value.

Next, the position correction in the main scanning direction will be described. Assume that the start positions of the cyan patterns 81-11, 81-12, 81-13 are shifted in the main scanning direction with respect to the start positions of the magenta patterns 81-21, 81-22, 81-23. For example, when the magenta patterns 81-21, 81-22, 81-23 are defined as a reference pattern, the shift between the start position of the cyan pattern and the start position of the magenta pattern is corrected to be 0. By the correction processing, the starting position (writing position) of the visible image of cyan and the starting position (writing position) of the visible image of magenta are corrected so as to coincide with each other.

Additionally, in the correction processing, a main scanning direction magnification correction processing, a sub-scanning direction magnification correction processing, and the like can also be performed.

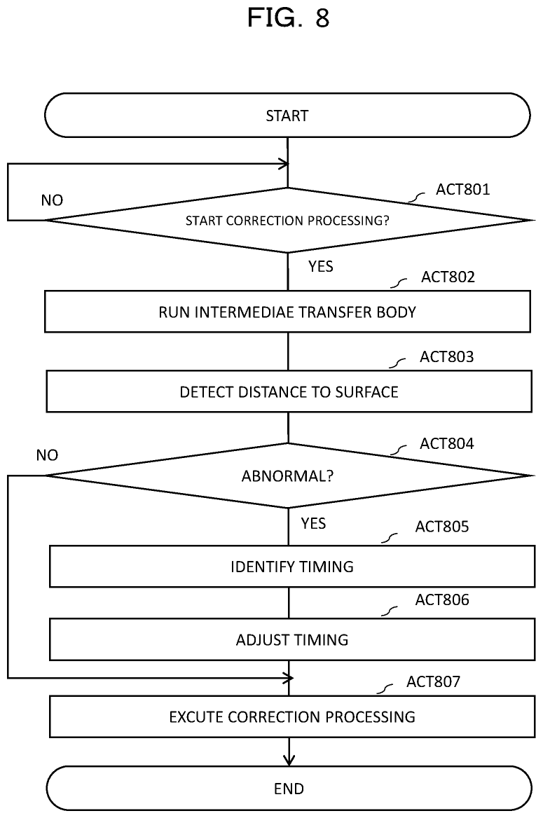

FIG. 8 is a flowchart illustrating an example of the alignment correction process performed by the image forming apparatus 100. As shown in FIG. 8, the controller 70 determines whether or not the alignment correction processing is to be started (ACT 801). The time at which the correction processing starts is, for example, when a predetermined number of sheets have been printed, or when a predetermined operating temperature has been reached. However, in general, the time at which the correction processing is performed may be any arbitrary time, such as the time at which the correction processing is initiated by a service technician or a user.

The controller 70 waits until the time for starting the correction processing has been reached (ACT 801, NO). When the correction process is to be started (ACT 801, YES), the correction controller 72 controls the drive motor to run the intermediate transfer body 31 in the state where no image has been formed (ACT 802). Then, the image density sensor 90 detects the distance to the surface of the intermediate transfer body 31 (more particularly in this example the surface of the transfer belt 31a) (ACT 803). Further, the detector 73 analyzes the output result of the image density sensor 90, and determines whether or not there is an abnormality in the intermediate transfer body 31 (ACT 803). Specifically, in ACT 803, the detector 73 determines whether or not the output value of the image density sensor 90 is within the range of 4.470V to 4.540V.

When there is no abnormality in the surface of intermediate transfer body 31 (ACT 804, NO), that is, when the output value of the image density sensor 90 is entirely within the range of 4.470V to 4.540V, the controller 70 proceeds to ACT 806. When there is an abnormality in the surface of the intermediate transfer body 31 (ACT 804, YES), the correction controller 72 identifies the timing (abnormal timing) at which abnormality is detected by the detector 73, in the cycle in which the intermediate transfer body 31 rotates (ACT 805). Then, the correction controller 72 adjusts the timing of the correction processing of the alignment to be performed by the correction processor 71 (ACT 806) then executes the correction processing (ACT 807) accordingly.

Specifically, the correction controller 72 performs control so that the correction processing is not performed during those times corresponding to the abnormality that has been detected by the detector 73. More specifically, the correction controller 72 adjusts the timing of the correction process so that the test pattern is not read by the position sensor 80 at the times corresponding to the abnormal position 601 and the abnormal position 602 (shown in FIG. 6) or the like, which are detected to repeat according to the rotational period of the intermediate transfer body 31.

Further, the correction controller 72 adjusts the timing of the correction process so that a test pattern can be formed in a portion (e.g., section 610 shown in FIG. 6) of the intermediate transfer body 31 where deviation of the intermediate transfer body 31 is relatively small. Note that the correction controller 72 can adjust the position at which the test pattern is formed to be within the section 610 so that the test pattern will not be read at the abnormal times. That is, the correction controller 72 causes the correction processor 71 to perform correction processing so that the deviation of the intermediate transfer body 31 is relatively small, and the times at which the test pattern is to be read is inhibited so as not to correspond to the known abnormal times.

Incidentally, since the position at which the deviation on the intermediate transfer body 31 is detected can be different from the position at which the test pattern is read, there is a possibility of reading the test pattern at an abnormal timing if the test pattern is formed at a position for which the deviation of the intermediate transfer body 31 is relatively small. In such a case, the correction controller 72 may avoid the reading at the abnormal timing even though the test pattern was not formed at a position for which the deviation of the intermediate transfer body 31 was relatively small.

After the timing of the correction processing is adjusted, the correction processor 71 executes the correction processing for the alignment (ACT 807), and ends the processing.

As described above, the image forming apparatus 100 detects a deviation from the reference position on the conveying surface of the intermediate transfer body 31, and controls the position on the conveying surface used for forming the test pattern in the correction process based on the detection result. Thereby, correction processing can be performed to avoid a position where a flaw is known to be present on the intermediate transfer body 31 and a position and timing at which fluttering occurs on the surfaces of the intermediate transfer body 31 can be compensated for. Therefore, the accuracy in correcting the positional deviation can be improved, so that the image quality can be improved.

In addition, the image forming apparatus 100 according to the embodiment is configured such that the transfer body is allowed to run at least once before the correction processing is fully initiated, the times at which an abnormality is detected can thus be specified in the running of the transfer body, and at least some of the correction processing can be adjusted to avoid prohibited times. Accordingly, the correction processing can be performed while avoiding the times at which fluttering occurs on the surface of the intermediate transfer body 31.

In addition, the image forming apparatus 100 can prohibit the reading processing in the correction processing to avoid the abnormality times. That is, when fluttering occurs in the intermediate transfer body 31, it is the reading processing which is most likely to be affected by the fluttering, so, in some examples, only the image reading processes associated with correction processes are controlled to avoid the known/detected abnormality times. This makes it possible to further improve the accuracy in correcting the positional deviation without unduly limiting the available times/positions for printing associated with the correction processing.

In addition, the image forming apparatus 100 of the embodiment can execute the transfer process at the timing at which the abnormality occurs. Accordingly, even if the intermediate transfer body 31 is fluttering, it is possible to form a test pattern which is not substantially affected by the fluttering, so that it is possible to complete the correction process quickly.

In addition, in the embodiment, the detector 73 detects the deviation of the intermediate transfer body 31 based on the output result of the image density sensor 90. Thus, it is possible to detect the deviation or abnormality of the surfaces of the intermediate transfer body 31 without providing a new sensor or device component. That is, the image density sensor 90 already used for detecting the image density can be used for this additional purpose. Therefore, the image forming apparatus 100 can improve the accuracy in positional corrections without increasing the number of device components, which in turn can avoid the need for any increase in the size of the image forming apparatus 100, and/or an increase in cost of the image forming apparatus.

In the image forming apparatus 100 of the embodiment, a test pattern is formed at a position where the deviation detected by the detector 73 is relatively small (e.g., section 610 in FIG. 6). Thus, since the test pattern can be formed in a place where the intermediate transfer body 31 is less likely to flutter, it is possible to improve the accuracy in correcting the positional deviation.

In the image forming apparatus 100 of the embodiment, a reinforced member 500 having a seam line 501 is provided on the outer periphery of the edge portion of the intermediate transfer body 31. Therefore, when the seam line 501 of the reinforced member 500 passes over the support roller 33c, an abnormality is likely to occur. However, according to the image forming apparatus 100 of the embodiment, correction processing can be performed in consideration of looseness/abnormality occurring when the seam line 501 of the reinforced member 500 rides over the support roller 33c. Therefore, it is still possible to accurately correct or account for the positional deviation without separately providing a device or an apparatus for suppressing such fluttering.

In the image forming apparatus 100 of the embodiment, the rib 510 having the seam 501 is provided on the outer periphery of the side portion of the intermediate transfer body 31. Therefore, when the joint 511 of the rib 510 passes over the support roller 33c, an abnormality is likely to occur. According to the image forming apparatus 100 of the embodiment, the correction processing can be performed in consideration of looseness/abnormality occurring when the joint 511 of the rib 510 passes over the support roller 33c. Therefore, it is still possible to accurately correct the positional deviation without separately providing a device or an apparatus specifically for suppressing such fluttering.

In the image forming apparatus 100 of the embodiment, the conveying roller 33 includes a first support roller 33a in which a nip area is formed, and a second support roller 33c in which a nip area is not formed. Therefore, the abnormality of the surface of the intermediate transfer body 31 is unlikely to occur when the seam line 501 and the joint 5111 of the transfer body 31 passes over the first support roller 33a in which the nip area is formed (see FIG. 5), and is likely to occur when the seam line 501 and the joint 511 of the transfer body 31 pass over the second support roller 33c in which the nip area is not formed. According to the image forming apparatus 100 of the present embodiment, when the seam line 501 and the joint 511 pass over the support roller 33c in which the nip area is not formed, the correction processing can be inhibited when the fluttering/abnormality occurs. Therefore, it is possible to correct the positional deviation with high accuracy. Further, when the seam line 501 and the joint 511 pass over the first support roller 33a in which the nip area is formed, the correction process can be carried out. Therefore, it is possible to complete the correction processing quickly.

In addition, the image forming apparatus 100 according to the embodiment is configured such that, immediately before the correction processing is performed, the intermediate transfer body 31 is allowed to run once to identify the timing at which the abnormality is detected in the running. Accordingly, the abnormality immediately before the correction processing can be detected, so that the accuracy at the time when the positional deviation is corrected can be improved.

Next, a modified example of the present embodiment will be described. In the following description, the points described in the above embodiment are denoted by the same reference numerals, and description thereof will not be repeated. In the embodiment described above, the timing at which abnormality occurs in the surface of the intermediate transfer body 31 is specified with reference to a reference point.

In a modified example, a mark indicating a reference point (also referred to as a home position) is provided on the intermediate transfer body 31, whereby the timing at which the abnormality occurs can be specified by reference to the reference point indicated by the mark (the home position). Specifically, in a modification, image forming apparatus 100 includes a reference point detector (also referred to as a mark sensor) that detects the mark on the intermediate transfer body 31. Further, the memory 65 stores information about positions where an abnormality occurs on the intermediate transfer body 31, with reference to the reference point (mark). The information regarding the position is information indicating the timing at which the abnormality is detected (abnormal timing), or information on the position at which the abnormality is detected, based on the reference point.

Here, a description will be given of correction controller 72 storing position-based abnormality information in the memory 65. Before the correction processing by the correction processor 71, the correction controller 72 causes the intermediate transfer body 31 to rotate to the reference point based on the detection result of the reference point detector. The correction controller 72 specifies information regarding the position where an abnormality has been detected by the detector 73 during the traveling of the transfer body 31. Specifically, the correction controller 72 identifies the timing at which the abnormality is detected (abnormal timing) and the position where the abnormality occurs (abnormal position), based on the timing at which the mark was detected by the reference point detector.

Then, the correction controller 72 stores the information about the specified position in the memory 65. For example, the correction controller 72 identifies the abnormal timing and the abnormal position only a single time before the correction processing by the correction processor 71, and stores information indicating the specified abnormal timing and the abnormal position in the memory 65. That is, in the modification, the correction controller 72 does not separately identify the abnormal timing or the abnormal position before each correction processing, but rather relies on the previously stored information.

When a correction process is performed, the correction controller 72 controls the position on the conveying surface to which the test pattern is to be formed, based on the reference point detected by the reference point detector and the information on the position stored in the memory 65. Specifically, the correction controller 72 prohibits at least some of the correction processing (for example, reading processing of the test pattern) at the abnormal timing, and controls the position at which the test pattern is to be formed on the surface of the intermediate transfer body 31. Thus, the correction processor 71 can perform the correction processing while avoiding the abnormal times and the abnormal positions based on the reference point.

The correction controller 72 may periodically re-identify the abnormal times and the abnormal positions, and may appropriately update the stored information in the memory 65. The correction controller 72 does not need to separately identify the abnormal times or the abnormal positions before the start of the correction process, but rather may simply refer to already stored information.

Further, the correction controller 72 prohibits at least some of the correction processing according to the information stored in the memory 65. Specifically, the correction controller 72 inhibits at least a test pattern from being read out at the times at which an abnormality occurs.

Note that the correction controller 72 does not necessarily store the information about which positions on the surface of the intermediate transfer body 31 are abnormal in the memory 65, but rather may store information about the positions on the surface of the intermediate body 31 at which there is no abnormality in the memory 65. The position information for those positions for which no abnormality occurs on the surface of intermediate transfer body 31 is, for example, information indicating normal times and/or normal positions on the intermediate transfer body 31. In this case, the correction controller 72 may perform correction processing at the normal times and/or the normal positions as indicated by the information stored in the memory 65.

According to the modification described above, the accuracy in correcting positional deviations in image forming processes can be improved, so that the image quality can be improved. In particular, in the modification described above, when the correction processing is performed, the position on the conveying surface for forming the test pattern is controlled based on the reference point detected by the reference point detector and the information on the position stored in the memory 65. Therefore, the correction controller 72 can obtain the information by only storing information about the position where the abnormality occurs, in the memory 65. Therefore, when the correction processing by the correction processor 71 is performed, it is possible to quickly obtain information on the abnormal timing and the abnormal position without causing the intermediate transfer body 31 to run once, or to obtain the detection result of the detector 73. Therefore, it is possible to realize a rapid correction process, and it is possible to reduce the load of the processing related to the prohibition of the correction process.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed:

1. An image forming apparatus, comprising,
an image forming unit configured to transfer an image from a photoconductor to a transfer body and then transfer the image from the transfer body to a sheet;
a detector configured to detect a positional deviation of a conveying surface of the transfer body from a reference position; and
a controller configured to:
execute a correction processing including forming a test pattern on the conveying surface of the transfer body, and
execute a correction control processing including forming the test pattern for the correction processing based on a detection result from the detector.

2. The image forming apparatus according to claim 1 wherein,
the detector is configured to detect an abnormality of the conveying surface based on the deviation, and
the correction control processing further includes:
rotating the transfer body by at least one circumferential distance,
detecting the times at which the abnormality is detected by the detector during the rotation of the transfer body, and
prohibiting at least a part of the correction processing at times or positions corresponding to the detected abnormality.

3. The image forming apparatus according to claim 2 wherein, a reading of the test pattern in the correction processing is prohibited at times or positions corresponding to the detected abnormality.

4. The image forming apparatus according to claim 2 wherein,
the correction processing further includes transferring the test pattern to the transfer body, and
the correction control processing further includes enabling the transferring of the test pattern to be executed at the specified timing.

5. The image forming apparatus according to claim 1 wherein, the detector is an image density sensor configured to detect the image density of the image on the transfer body.

6. The image forming apparatus according to claim 1 wherein, the correction control processing includes forming the test pattern at a position where the deviation is relatively small.

7. The image forming apparatus according to claim 1 wherein, the transfer body is a transfer belt.

8. The image forming apparatus according to claim 7 wherein, the transfer belt is stretched around a conveying roller, has a rib portion proximate to an outer peripheral edge and a reinforcing member proximate to the outer peripheral edge.

9. The image forming apparatus according to claim 8 wherein, the transfer belt includes:
a seam portion at which the reinforcing member is sewn to the transfer belt, and
a gap portion in the rib at which ends of the rib along a rotational length of the transfer belt are adjacent.

10. The image forming apparatus according to claim 1 further comprising:
a reference point detector configured to detect a reference point disposed on the transfer body; and
a storage unit configured to store abnormality information for the transfer body in reference to the detected reference point disposed on the transfer body, wherein
the correction control processing further includes:
controlling the position at which the test pattern is formed by positioning the transfer body using the detected reference point and the stored abnormality information from the storage unit.

11. The image forming apparatus according to claim 1, wherein the test pattern comprises:
a first test pattern at a front side portion of the transfer body,
a second test pattern at a center portion of the transfer body, and
a third test pattern on a rear side portion of the transfer body.

12. The image forming apparatus according to claim 11, wherein a first distance between the first test pattern and the second test pattern along a main scanning direction is different from a second distance along the main scanning direction between the second test pattern and the third test pattern.

13. The image forming apparatus according to claim 11, wherein the detector comprises a first detector positioned to detect the first test pattern, a second detector positioned to detect the second test pattern, and a third detector positioned to detect the third test pattern.

14. The image forming apparatus according to claim 11, wherein the first, second, and third test patterns are wedge shaped test patterns having a first line segment extending in a main scanning direction and a second line segment extending in an oblique direction with respect to the main scanning direction.

15. The image forming apparatus according to claim 14, wherein the test pattern further comprises a plurality of first, second, and third test patterns arranged in a sub-scanning direction on the transfer body, the plurality of first, second, and third test patterns corresponding to different colors of the image forming unit.

16. The image forming apparatus according to claim 15, wherein the correction control processing further includes adjusting the image forming unit such that a distance between the plurality of first, second, and third test patterns in the sub-scanning direction matches a reference value.

17. The image forming apparatus according to claim 1, wherein the controller is configured to start the correction processing after a predetermined number of sheets have been printed.

18. A method of operating an image forming apparatus, comprising:
detecting a distance to a transfer body from an optical sensor;
determining if there is an abnormality in the transfer body based on the detected distance;
executing a correction process that includes forming a test pattern on the transfer body, the correction process being varied to account for any determined abnormality in the transfer body.

19. The method according to claim 18, further comprising:
rotating the transfer body for at least one revolution prior to determining the abnormality.

20. The method according to claim 18, further comprising:
identifying a position of the abnormality on the transfer body by reference to a point on the transfer body indicated with a reference mark disposed on the transfer body.
